(19) United States
(12) Patent Application Publication
(10) Pub. No.: US 2018/0008895 A1
(43) Pub. Date: Jan. 11, 2018

(54) VIDEO GAME PROCESSING PROGRAM, AND VIDEO GAME PROCESSING SYSTEM

(71) Applicant: KABUSHIKI KAISHA SQUARE ENIX (also trading as SQUARE ENIX CO., LTD.), Tokyo (JP)

(72) Inventors: Jiro MIFUNE, Tokyo (JP); Shinpei SAKATA, Tokyo (JP)

(73) Assignee: KABUSHIKI KAISHA SQUARE ENIX (also trading as SQUARE ENIX CO., LTD.), Tokyo (JP)

(21) Appl. No.: 15/643,845

(22) Filed: Jul. 7, 2017

(30) Foreign Application Priority Data
Jul. 8, 2016 (JP) 2016-135979

(51) Int. Cl. A63F 13/58; A63F 13/45; A63F 13/822; G06F 3/0482

(52) U.S. Cl. CPC A63F 13/58; G06F 3/0482; A63F 13/45; A63F 13/822

(57) ABSTRACT

A non-transitory computer-readable medium including a video game processing program product for causing a server to realize functions to control progress of a video game in response to an operation of a user is provided. The functions include: a first setting function configured to set an ability to an available state when a predetermined available condition for the ability is satisfied, the ability being associated with an in-game element in the video game; and a second setting function configured to set a combination ability to an available state, the combination ability corresponding to a combination of an in-game element selected by the user and the ability that has become the available state by the setting of the first setting function.

### CROSS-REFERENCE TO RELATED APPLICATION

The present application relates to subject matter contained in Japanese Patent Application No. 2016-135979 field on Jul. 8 2016, the disclosure of which is expressly incorporated herein by reference in its entirety.

### BACKGROUND OF THE INVENTION

### 1. Field of the Invention

At least one of embodiments according to the present invention relates to a non-transitory computer-readable medium including a video game processing program and a video game processing system for causing a server to realize functions to control progress of a video game in response to an operation of a user.

### 2. Description of the Related Art

Heretofore, in a video game, there has been a system in which each of a player character and other in-game elements is associated with an Ability; and the Ability can be used when a predetermined condition is satisfied. Here, the word “Ability” is a capacity (or an ability) that the player character or the like is allowed to use in the video game. The “Ability” may be expressed by a “skill” in some video games. By allowing the player character or the like to use the Ability, there are effects to increase a quality of the video game due to the Ability, such as an increase in the number of commands that a user can select, and a rise in a capacity parameter (or an ability parameter) of the player character.

As one in which an Ability is associated with an in-game element in a video game, Japanese Patent Application Publication No. 2016-52591 (hereinafter, referred to as “Patent Document 1”) is cited, for example. This Patent Document 1 discloses that an Ability is associated with a game medium (for example, a card, a character, a weapon, a protective guard or an item of the video game, and the like), and it is defined whether the Ability can be used in accordance with a level of the game medium having the Ability or not.

In Patent Document 1, the game medium and the Ability are associated with each other by one-to-one correspondence. Thus, in a case where the game medium is a player character, for example, a user can receive a benefit of the Ability when the user uses the player character that is allowed to use the Ability. However, the user switches the player character to other player character, the user cannot receive the benefit of the Ability obtained when the player character is allowed to use the Ability. In such a case, a user who uses only a specific player character always receives the benefit of the Ability. Therefore, there has been a fear that a user who brought up the specific player character strongly has a low motivation to use other player character.

### SUMMARY OF THE INVENTION

It is an object of at least one of embodiments according to the present invention to solve the problem described above, and to provide a non-transitory computer-readable medium including a video game processing program product capable of encouraging a user to use an in-game element widely in a video game.

According to one non-limiting aspect of the present invention, there is provided a non-transitory computer-readable medium including a video game processing program product for causing a server to realize functions to control progress of a video game in response to an operation of a user.

The functions include a first setting function configured to set an ability to an available state when a predetermined available condition for the ability is satisfied, the ability being associated with an in-game element in the video game.

The functions also include a second setting function configured to set a combination ability to an available state, the combination ability corresponding to a combination of an in-game element selected by the user and the ability that has become the available state by the setting of the first setting function.

According to another non-limiting aspect of the present invention, there is provided a non-transitory computer-readable medium including a video game processing program product for causing a user terminal to realize functions to control progress of a video game in response to an operation of a user.

The functions include a first setting function configured to set an ability to an available state when a predetermined available condition for the ability is satisfied, the ability being associated with an in-game element in the video game.

The functions also include a second setting function configured to set a combination ability to an available state, the combination ability corresponding to a combination of an in-game element selected by the user and the ability that has become the available state by the setting of the first setting function.

According to still another non-limiting aspect of the present invention, there is provided a video game processing system for controlling progress of a video game in response to an operation of a user, the video game processing system including a communication network, a server, and a user terminal.

The video game processing system includes a first setting section configured to set an ability to an available state when a predetermined available condition for the ability is satisfied, the ability being associated with an in-game element in the video game.

The video game processing system also includes a second setting section configured to set a combination ability to an available state, the combination ability corresponding to a combination of an in-game element selected by the user and the ability that has become the available state by the setting of the first setting section.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a video game processing system corresponding to at least one of embodiments according to the present invention.

FIG. 2 is a block diagram showing a configuration of a video game processing server corresponding to at least one of the embodiments according to the present invention.

FIG. 3 is a flowchart showing an example of game processing corresponding to at least one of the embodiments according to the present invention.

FIG. 4 is a flowchart showing an example of an operation of a server side in the game processing corresponding to at least one of the embodiments according to the present invention.

FIG. 5 is a flowchart showing an example of an operation of a user terminal side in the game processing corresponding to at least one of the embodiments according to the present invention.

FIG. 6 is a block diagram showing a configuration of a video game processing server corresponding to at least one of the embodiments according to the present invention.

FIG. 7 is a flowchart showing an example of an operation of the server side in the game processing corresponding to at least one of the embodiments according to the present invention.

FIG. 8 is a block diagram showing a configuration of a video game processing server corresponding to at least one of the embodiments according to the present invention.

FIG. 9 is a flowchart showing an example of an operation of the server side in the game processing corresponding to at least one of the embodiments according to the present invention.

FIG. 10 is a block diagram showing a configuration of a video game processing server corresponding to at least one of the embodiments according to the present invention.

FIG. 11 is a flowchart showing an example of an operation of the server side in the game processing corresponding to at least one of the embodiments according to the present invention.

FIG. 12 is a block diagram showing a configuration of a video game processing server corresponding to at least one of the embodiments according to the present invention.

FIG. 13 is a flowchart showing an example of an operation of the server side in the game processing corresponding to at least one of the embodiments according to the present invention.

FIG. 14 is an explanatory drawing for explaining a concept corresponding to at least one of the embodiments according to the present invention.

FIG. 15 is an explanatory drawing for expressing one example of a game screen corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like did not occur in the content of the processing.

### First Embodiment

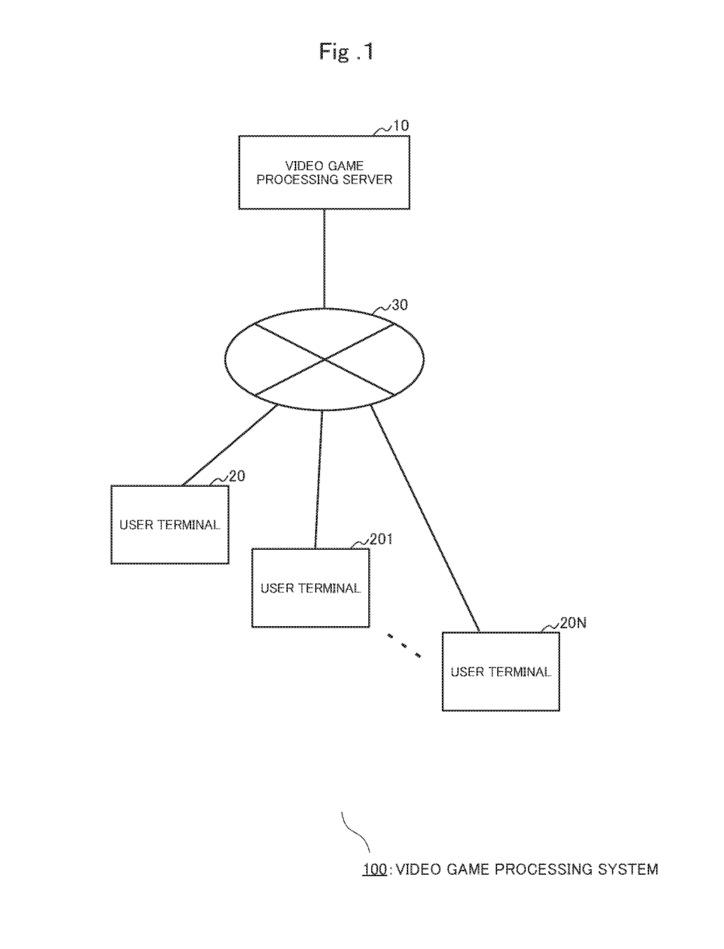

FIG. 1 is a block diagram showing an example of a configuration of a video game processing system 100 according to one embodiment of the present invention. As shown in FIG. 1, the video game processing system 100 includes a video game processing server 10 (hereinafter, referred to as a “server 10”) and user terminals 20 and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The video game processing system 100 includes the server 10 and the plurality of user terminals 20 and 201 to 20N, whereby various kinds of functions for carrying out various kinds of processing in response to an operation of the user is realized.

The server 10 is managed by an administrator of the video game processing system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. In this regard, the server 10 is provided with a general configuration for carrying out the various kinds of processing as a computer, such as a control section and a communicating section. However, its explanation herein is omitted. Further, in the video game processing system 100, it is preferable that the server 10 manages various kinds of information from a point of view to reduce a processing load on each of the plurality of user terminals 20 and 201 to 20N. However, a storing section for storing various kinds of information may include a storage region in a state that the server 10 can access the storage region. For example, the server 10 may be configured so as to be provided with a dedicated storage region outside the server 10.

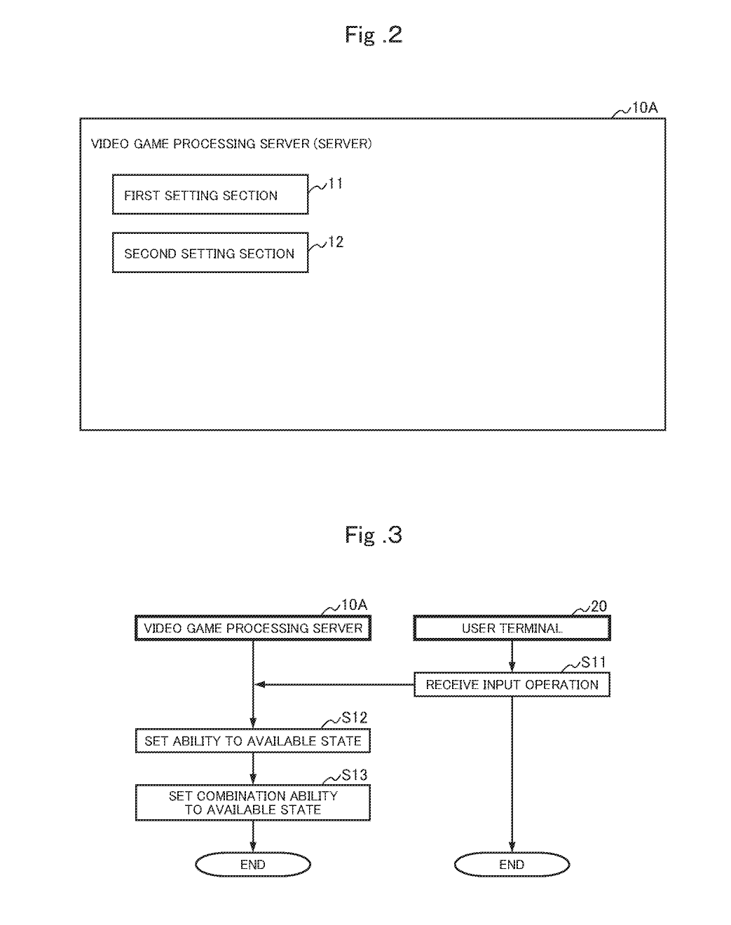

FIG. 2 is a block diagram showing a configuration of a video game processing server 10A (hereinafter, referred to as a “server 10A”), which is an example of the configuration of the server 10. As shown in FIG. 2, the server 10A at least includes a first setting section 11 and a second setting section 12.

The first setting section 11 has a function to set an Ability to an available state when a predetermined available condition for the Ability is satisfied. The Ability is associated with an in-game element in a video game.

The in-game element is an element in the video game, which is provided to cause the user to use. As examples of the in-game element, there are a player character associated with the user, a job (or an occupation) of the player character, and an Ability that the player character is allowed to use, for example.

The Ability means a capacity (or an ability) that the player character or the like is allowed to use in the video game. The Ability may be expressed by a skill in some video games. Further, the available state for the Ability means that it becomes a state where an Ability is allowed to be combined with the in-game element in the second setting section 12 (will be described later). In a case where usage of the Ability is mentioned, usage such as an increase in the number of commands that the user can select for the player character or the like, and a rise in a capacity parameter (or an ability parameter) of the player character is thought. However, in a case where expression “available state” is used in the present embodiment, the “available state” at least includes a state that an Ability can be combined with an in-game element. It is noted that the user should set to either usage as a command or usage as a rise in the capacity parameter (or the ability parameter) appropriately at the same time when the Ability can be combined with the in-game element. In the present embodiment, the user may select either the usage as the command or the usage as the rise in the capacity parameter.

The second setting section 12 has a function to set a combination Ability to an available state. The combination Ability corresponds to a combination of an in-game element selected by the user and an Ability that is set to an available state. This configuration to carry out a process for setting the combination Ability in the second setting section 12 is not limited particularly. However, it is preferable that the server 10A is configured so that the user at least selects an in-game element to be combined. As an example of such a configuration, a configuration in which: selection of an in-game element by the user is received; when the in-game element is determined, an Ability that automatically becomes an available state is combined with the in-game element to form a combination Ability; and the combination Ability is set to an available state, is thought. Further, the configuration when the combination Ability is set to the available state is not limited particularly. However, it is preferable that usage as a command that is an option of an action of the player character and usage as a rise in the capacity parameter (or the ability parameter) of the player character are possible with respect to the combination Ability that becomes, became or has become the available state, for example.

Each of the plurality of user terminals 20, 201 to 20N is managed by a user, and is configured by a communication terminal, such as a cellular phone terminal, a PDA (Personal Digital Assistants), a mobile game device, and a so-called wearable divide, by which the user can play a network delivery type game, for example. In this regard, a configuration of the user terminal that the video game processing system 100 can include is not limited to the examples described above. It may be a configuration in which the user can recognize the video game. As other examples of the user terminal, there is a combination of a so-called wearable device, such as a smart watch, and a communication terminal or the like configured to communicate with the wearable device.

Further, each of the plurality of user terminals 20, 201 to 20N is connected to the communication network 30, and includes hardware (for example, a display device for displaying a browser screen and a game screen according to a coordinate and the like) and software for carrying out various kinds of processing by communicating with the server 10. In this regard, each of the plurality of user terminals 20, 201 to 20N may be configured so as to be capable of directly communicating with each other without the server 10.

Next, an operation of the video game processing system 100 according to the present embodiment will be described.

FIG. 3 is a flowchart showing an example of game processing carried out by the video game processing system 100 (hereinafter, referred to as the “system 100”). Hereinafter, the case where the server 10A and a user terminal 20 (hereinafter, referred to as a “terminal 20”) carry out the game processing will be described as an example.

The game processing is started when the user terminal 20 receives an input operation carried out by the user, for example (Step S11). In the game processing, determination to whether a predetermined available condition for an Ability associated with an in-game element is satisfied or not is carried out as a premise (in which description of steps in the drawing is omitted). When the available condition for the Ability is satisfied, the first setting section 11 sets the Ability to an available state (Step S12). Then, when the user selects an in-game element, the second setting section 12 sets a combination Ability, which corresponds to a combination of the in-game element selected by the user and the Ability that becomes, became or has become the available state, to an available state (Step S13).

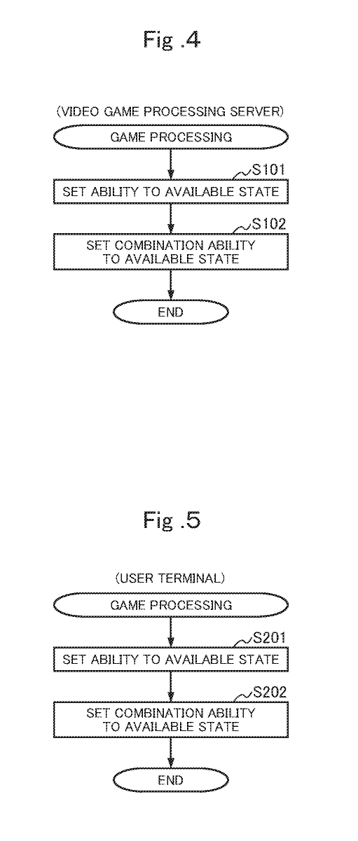

FIG. 4 is a flowchart showing an example of an operation of the server 10A side in the game processing. Here, an operation of the server 10A in the video game processing system 100 will be described.

In the server 10A, the game processing is started at the time when it is determined that an available condition of an Ability is satisfied. In the game processing, determination to whether a predetermined available condition for an Ability associated with an in-game element is satisfied or not is carried out as a premise (in which description of steps in the drawing is omitted). When the available condition for the Ability is satisfied, the first setting section 11 sets the Ability to an available state (Step S101). Then, when the user selects an in-game element, the second setting section 12 sets a combination Ability, which corresponds to a combination of the in-game element selected by the user and the Ability that has become the available state, to an available state (Step S102).

FIG. 5 is a flowchart showing an example of an operation of the user terminal 20 side in a case where the user terminal 20 carries out the game processing. Hereinafter, the case where the user terminal 20 carries out the game processing by a single body will be described as an example. In this regard, the configuration of the user terminal 20 includes the similar functions to those of the server 10 except that the user terminal 20 receives various kinds of information from the server 10. For this reason, its description is omitted from a point of view to avoid repeated explanation.

In the user terminal 20, the game processing is started at the time when it is determined that an available condition of an Ability is satisfied. In the game processing, determination to whether a predetermined available condition for an Ability associated with an in-game element is satisfied or not is carried out as a premise (in which description of steps in the drawing is omitted). When the available condition for the Ability is satisfied, the user terminal 20 sets the Ability to an available state (Step S201). Then, when the user selects an in-game element, the user terminal 20 sets a combination Ability, which corresponds to a combination of the in-game element selected by the user and the Ability that has become the available state, to an available state (Step S202).

As explained above, as one side of the first embodiment, the server 10A provided with the functions to control progress of the video game in response to an operation of the user is configured so as to include the first setting section 11 and the second setting section 12. In this case, the server 10A is configured so that the first setting section 11 sets the Ability to the available state when the predetermined available condition for the Ability associated with the in-game element in the video game is satisfied; and the second setting section 12 sets the combination Ability, which corresponds to a combination of the in-game element selected by the user and the Ability that has become the available state, to an available state when the user selects the in-game element. Therefore, it becomes possible to encourage the user to use the in-game element widely.

Namely, by setting the combination Ability according to the combination of the Ability that has become the available state and the in-game element, it is possible to use a combination Ability by combining the Ability that has become the available state on the basis of an in-game element with other in-game element. Therefore, the user may have motivation to use the in-game element, and as a result, it becomes possible to encourage the user to use the in-game element widely. For that reason, the server 10A may be configured so that a player character is adopted as an in-game element and an Ability becomes an available state by bringing up the player character (that is, the Ability can be combined with other player character). This makes it possible to encourage a user who brought up a specific player character strongly to use other player character. Therefore, it is possible to resolve a fear that “a user who brought up the specific player character strongly has a low motivation to use other player character”.

### Second Embodiment

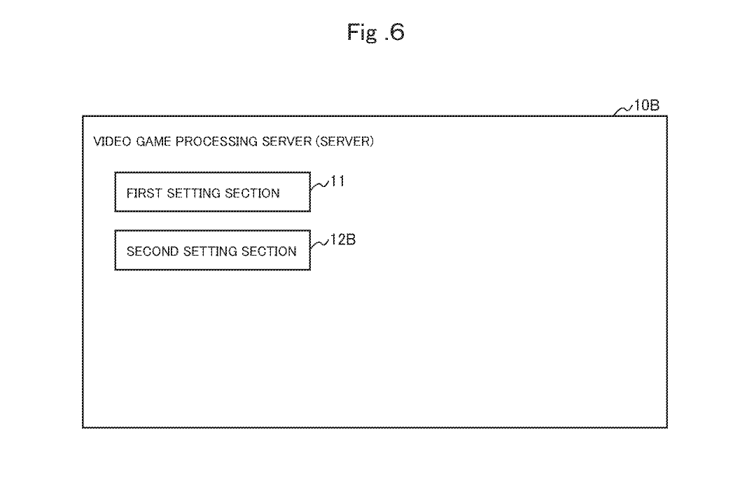

FIG. 6 is a block diagram showing a configuration of a video game processing server 10B (hereinafter, referred to as a “server 10B”), which is an example of the configuration of the server 10. As shown in FIG. 6, the server 10B at least includes a first setting section 11, and a second setting section 12B.

The second setting section 12B has a function to set a combination Ability to an available state. The combination Ability corresponds to a combination of an in-game element selected by a user and an Ability becomes an available state. Further, the second setting section 12B also has a function to determine an Ability that has become an available state to be combined with the in-game element on the basis of selection of the user. Namely, the second setting section 12B also has a function to cause the user to respectively select an in-game element and an Ability that has become an available state, and to set a combination Ability corresponding to the combination to an available state.

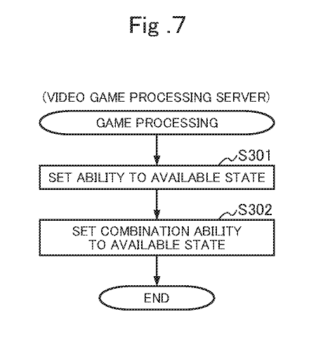

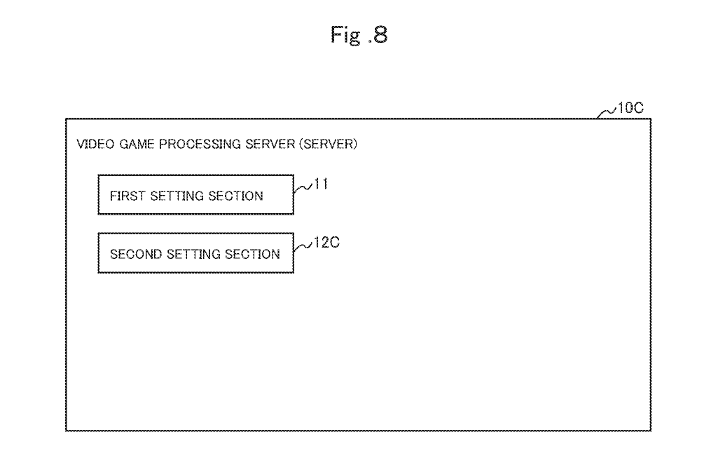

FIG. 7 is a flowchart showing an example of an operation of the server 10B side in the game processing. Here, an operation of the server 10B in the video game processing system 100 will be described.

In the server 10B, the game processing is started at the time when it is determined that an available condition of an Ability is satisfied. In the game processing, determination to whether a predetermined available condition for an Ability associated with an in-game element is satisfied or not is carried out as a premise (in which description of steps in the drawing is omitted). When the available condition for the Ability is satisfied, the first setting section 11 sets the Ability to an available state (Step S301). Then, when selection of an in-game element and selection of an Ability that has become an available state are carried out by the user, the second setting section 12B sets a combination Ability, which corresponds to a combination of the in-game element selected by the user and the Ability that has become the available state, to an available state (Step S302).

As explained above, as one side of the second embodiment, the server 10B provided with the functions to control progress of the video game in response to an operation of the user is configured so as to include the first setting section 11 and the second setting section 12B. In this case, the server 10B is configured so that the second setting section 12B mentioned herein determines the Ability that has become the available state to be combined with the in-game element on the basis of selection of the user. For this reason, it becomes possible to encourage the user to use the in-game element widely.

Namely, since the combination Ability can be set to the available state on the basis of the determination of the user, the user may generate a strategic characteristic to determine any combination, and the user may have motivation to try to combine various Abilities or in-game elements. For this reason, as a result, it becomes possible to encourage the user to use the in-game element widely.

### Third Embodiment

FIG. 8 is a block diagram showing a configuration of a video game processing server 10C (hereinafter, referred to as a “server 10C”), which is an example of the configuration of the server 10. As shown in FIG. 8, the server 10C at least includes a first setting section 11, and a second setting section 12C.

The second setting section 12C has a function to set a combination Ability to an available state. The combination Ability corresponds to a combination of an in-game element selected by a user and an Ability that has become an available state. At that time, the second setting section 12C allows the Ability that has become the available state to be combined with an in-game element different from the in-game element whose Ability is set to the available state. Namely, in a case where the Ability associated with the in-game element is set to the available state, the Ability can be combined with only other in-game element.

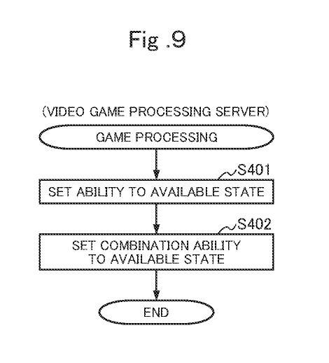

FIG. 9 is a flowchart showing an example of an operation of the server 100 side in the game processing. Here, an operation of the server 100 in the video game processing system 100 will be described.

In the server 100, the game processing is started from the time when it is determined that an available condition of an Ability is satisfied. In the game processing, determination to whether a predetermined available condition for an Ability associated with an in-game element is satisfied or not is carried out as a premise (in which description of steps in the drawing is omitted). When the available condition for the Ability is satisfied, the first setting section 11 sets the Ability to an available state (Step S401). Then, when the user selects an in-game element, the second setting section 12C sets a combination Ability, which corresponds to a combination of the in-game element selected by the user and the Ability that has become the available state, to an available state (Step S402). At that time, the Ability associated with the in-game element that is selected by the user cannot be combined with the in-game element. For this reason, the Ability that has become the available state is combined with an in-game element that is different from the in-game element.

As explained above, as one side of the third embodiment, the server 10C provided with the functions to control progress of the video game in response to an operation of the user is configured so as to include the first setting section 11 and the second setting section 12C. In this case, the server 10C is configured so that the second setting section 12C mentioned herein allows the Ability that has become the available state to be combined with an in-game element different from the in-game element whose Ability is set to the available state. For this reason, it becomes possible to encourage the user to use the in-game element widely.

Namely, even though the user sets an Ability associated with one in-game element to an available state, it is necessary to combine the Ability with other in-game element than the one in-game element in order to utilize the Ability. Therefore, the user may have motivation to select other in-game element, and as a result, it becomes possible to encourage the user to use the in-game element widely.

### Fourth Embodiment

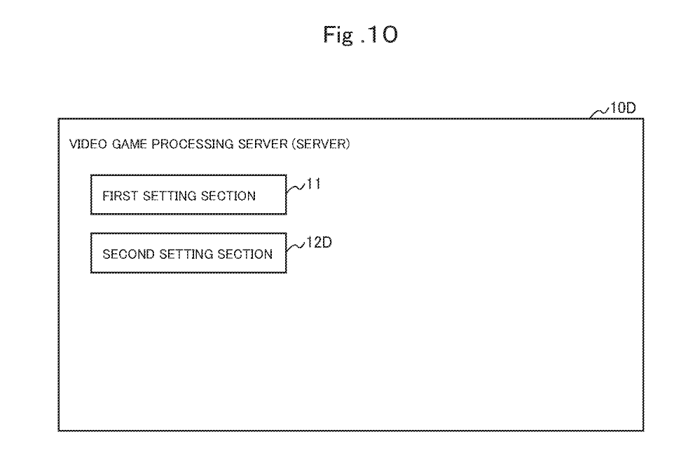

FIG. 10 is a block diagram showing a configuration of a video game processing server 10D (hereinafter, referred to as a “server 10D”), which is an example of the configuration of the server 10. As shown in FIG. 10, the server 10D at least includes a first setting section 11, and a second setting section 12D.

In the present embodiment, a setting frame for combining with an Ability that has become an available state is provided in an in-game element. Further, properties are respectively set for the setting frames. A combination Ability is set so as to be differentiated depending upon the property of the setting frame.

The second setting section 12D has a function to set a combination Ability, which corresponds to a combination of an Ability that has become an available state and a setting frame in an in-game element selected by a user, to an available state. Further, the second setting section 12D also has a function to determine a combination Ability on the basis of the Ability that has become the available state and a property of the setting frame.

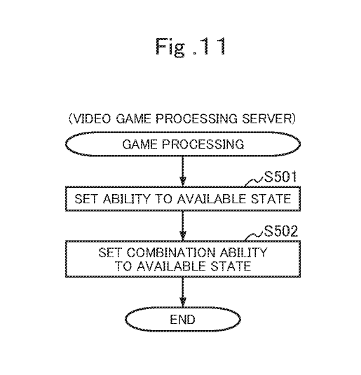

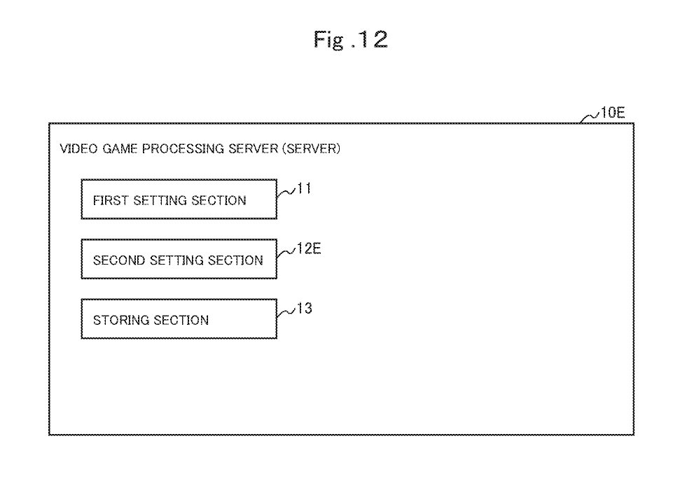

FIG. 11 is a flowchart showing an example of an operation of the server 10D side in the game processing. Here, an operation of the server 10D in the video game processing system 100 will be described.

In the server 10D, the game processing is started at the time when it is determined that an available condition of an Ability is satisfied. In the game processing, determination to whether a predetermined available condition for an Ability associated with an in-game element is satisfied or not is carried out as a premise (in which description of steps in the drawing is omitted). When the available condition for the Ability is satisfied, the first setting section 11 sets the Ability to an available state (Step S501). Then, when the user selects an in-game element, the second setting section 12D combines the Ability that has become the available state with a setting frame provided in the in-game element selected by the user, and set a combination Ability corresponding to the combination to an available state (Step S502). At that time, the property is set to the setting frame provided in the in-game element. When the Ability that has become the available state is combined with this setting frame, the second setting section 12D sets the combination Ability according to the property of this setting frame to the available state.

As explained above, as one side of the fourth embodiment, the server 10D provided with the functions to control progress of the video game in response to an operation of the user is configured so as to include the first setting section 11 and the second setting section 12D. In this case, the server 10D is configured so that the second setting section 12D mentioned herein determines the combination Ability on the basis of the Ability that has become the available state and the property of the setting frame provided in the in-game element. Therefore, it becomes possible to encourage the user to use the in-game element widely.

Namely, since the user is allowed to use the combination Ability according to the property of the setting frame, the user takes into consideration the property of the setting frame provided in the in-game element when to select the in-game element. Therefore, the user may have motivation to select various in-game elements by providing setting frames each of which has a different property for every in-game element, and as a result, it becomes possible to encourage the user to use the in-game element widely.

### Fifth Embodiment

FIG. 12 is a block diagram showing a configuration of a video game processing server 10E (hereinafter, referred to as a “server 10E”), which is an example of the configuration of the server 10. As shown in FIG. 12, the server 10E at least includes a first setting section 11, a second setting section 12E, and a storing section 13.

The first setting section 11 has a function to set an Ability associated with an in-game element in a video game to an available state when a predetermined available condition for the Ability is satisfied. The predetermined available condition means a case where a level of the Ability is raised to reach a predetermined level, for example. Then, the Ability whose level reaches the predetermined level becomes an available state to allow to be combined with other in-game element. Otherwise, any condition, such as a predetermined available condition to clear an event in the video game, may be set.

The second setting section 12E has a function to set a combination Ability to an available state. The combination Ability corresponds to a combination of an Ability that has become an available state with a setting frame in an in-game element selected by a user. At that time, the second setting section 12E also has a function to determine the combination Ability on the basis of the Ability that has become the available state and a property of the setting frame.

The storing section 13 has a function to store information on in-game elements in the video game, information on setting frames provided for each of the in-game elements, information on a property of each of the setting frames, information on Abilities, information on an available condition for each of the Abilities, information on combination Abilities, and the like therein, and a function to store a correspondence relationship of these kinds of information. More specifically, a correspondence relationship between a setting frame having a property and a combination Ability according to a combination of an Ability is stored in the storing section 13, for example. Further, in the present embodiment, a plurality of setting frames each of which has a different property is provided for one in-game element. A correspondence relationship between the in-game element and the plurality of setting frames is also stored in the storing section 13.

Further, in the present embodiment, a job (or an occupation) of a player character is set as the in-game element, and a plurality of setting frames is provided in this job. The job can be switched by selection of the user, for example. At least one Ability that is suitable for a property of the job is associated with each of the jobs. In a case where a predetermined condition is satisfied, the Ability becomes an available state. For example, it is thought that an Ability “thunder” is associated with a job “a warlock (or a wizard)”, and the Ability “thunder” becomes an available state in an initial state. Here, the initial state means a time when the user selects a job in the video game. This means that when the user selects the warlock, the Ability “thunder” has already became an available state.

Further, the server 10 appropriately transmits a processing procedure to the user terminal 20 in procedures carried out in the game processing. At the user terminal 20 side, a display device is caused to display a game screen based on the content of the received processing procedure on a display screen. In this regard, generation of a game screen may be carried out at the server 10C side, or carried out at the user terminal 20 side.

Here, the game screen means a screen representing a virtual space (or a game space). In this regard, in the present embodiment, various kinds of elements constituting the game screen may be called as an image. A configuration of the game screen is not limited particularly so long as it is a configuration in which the user can recognize a status of the video game.

Further, the phrase “display the game screen on the display screen of the display device” means that the game screen is outputted onto the display device included in the user terminal 20 or the like by means of communication using the communication network 30. As an example of a configuration to cause the display device to display the game screen, there is a configuration in which information generated at the server side (that is, output information) is transmitted to the terminal side. In this regard, a configuration of the output information is not limited particularly. For example, it may be information in which an image is compressed, or information for causing the terminal side to generate an image. As an example of the information in which the image is compressed, there is one used in a cloud game (for example, MPEG). Further, as information for generating an image at the terminal side, there is one used in an online game (for example, positional information of an object).

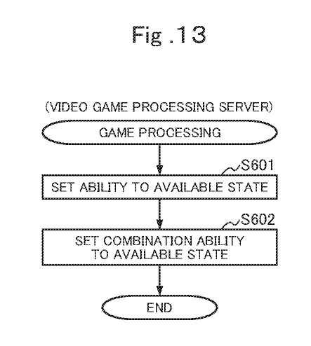

FIG. 13 is a flowchart showing an example of an operation of the server 10E side in the game processing. Here, an operation of the server 10E in the video game processing system 100 will be described.

In the server 10E, the game processing is started at the time when it is determined that an available condition of an Ability is satisfied. In the game processing according to the present embodiment, the server 10E appropriately refers to the storing section 13 to determine the content of the processing. In the game processing, determination to whether a predetermined available condition for an Ability associated with a job as an in-game element is satisfied or not is carried out as a premise (in which description of steps in the drawing is omitted) When the available condition for the Ability is satisfied, the first setting section 11 sets the Ability to an available state (Step S601). Then, when selection of a job as the in-game element is carried out by the user and an Ability that has become an available state is selected to be fitted to any of a plurality of setting frames provided for the job, the second setting section 12E sets combination Ability, which corresponds to a combination of the setting frame of the job selected by the user and the Ability that has become the available state, to an available state (Step S602). This combination Ability is determined in accordance with the Ability and a property of the setting frame of the job, and is stored in the storing section 13 in advance.

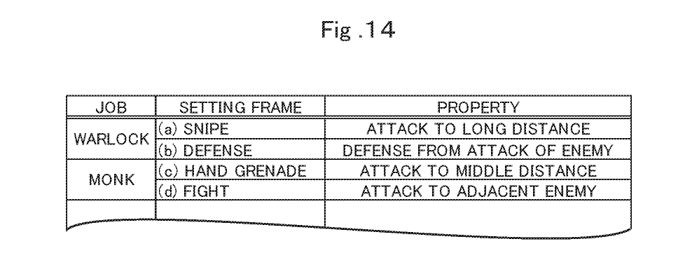

FIG. 14 is an explanatory drawing for expressing one example of a relationship among a job as an in-game element, a plurality of setting frames set to each of jobs, and a property of each of the setting frames. In FIG. 14, as one example of the job, a warlock and a monk are cited. Further, (a) snipe and (b) defense are cited as setting frames provided for the warlock, and (c) hand grenade and (d) fight are cited as setting frames provided for the monk. The setting frame “(a) snipe” has a property “an attack to a long distance”, the setting frame “(b) defense” has a property “defense from an attack of an enemy”, the setting frame “(c) hand grenade” has a property “an attack to a middle distance”, and the setting frame “(d) fight” has a property “an attack to an adjacent enemy”. This correspondence relationship as shown in FIG. 14 is set up in advance and stored in the storing section 13.

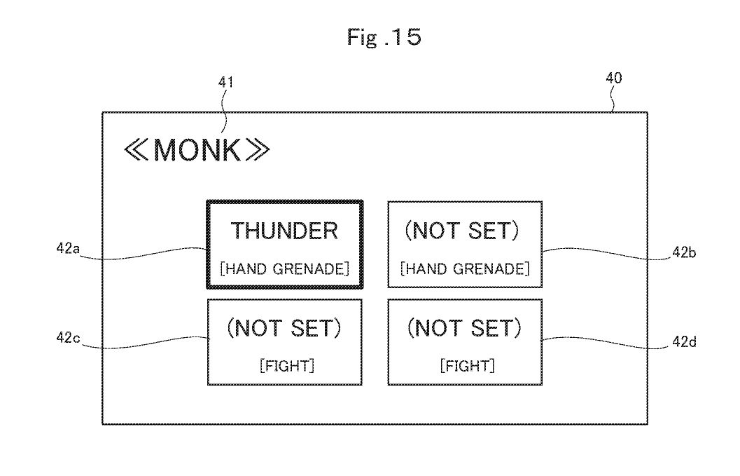

FIG. 15 is an explanatory drawing for expressing a game screen, in which an Ability is combined with a plurality of setting frames provided in a job, as one example of a game screen in which an in-game element and an Ability are combined. In FIG. 15, a game screen 40 is provided, and is displayed when an Ability is combined with a setting frame of a job. A job display column 41 and a plurality of setting frames 42a to 42d are provided in the game screen 40. The job display column 41 is used to express a job as an in-game element. In this example shown in FIG. 15, a “monk” is selected as the job. Each of the setting frames 42a, 42b provided for the job is a setting frame “hand grenade” that is the same property. Each of the setting frames 42c, 42d is a setting frame “fight” that is the same property.

FIG. 15 shows a state in which an Ability “thunder” is combined with the setting frame 42a “hand grenade”. When the setting frame “hand grenade” and the Ability “thunder” are combined, the second setting section 12E refers to the storing section 13, and sets a “hand grenade thunder” to an available state as a combination Ability. The combination Ability “hand grenade thunder” takes over the property “an attack to a middle distance” of the “hand grenade”. For this reason, it is thought that the combination Ability “hand grenade thunder” becomes a combination Ability having a property “a thunder attribution attack to a middle distance”. Further, no Ability is set to each of the setting frames “fight” 42c and 42d in FIG. 15. However, for example, it is thought that in a case where an Ability “thunder” is combined with this setting frame “fight”, a combination Ability takes over the property “an attack to an adjacent enemy” of the setting frame “fight” and a property of the Ability “thunder” to allow the user to use a combination Ability “thunder punch”.

As explained above, as one side of the fifth embodiment, the server 10E provided with the functions to control progress of the video game in response to an operation of the user is configured so as to include the first setting section 11, the second setting section 12E, and the storing section 13. In this case, a plurality of setting frames each of which has a different property from the other is provided in the in-game element, and the second setting section 12E causes the content of the combination Ability to become different from those of the others depending upon the property of the setting frame on the basis of which setting frame the ability is combined with even though the ability is the same Ability. Therefore, it becomes possible to encourage the user to use the in-game element widely.

Namely, by providing a plurality of setting frames, each of which has a different property than those of the other setting frames, in the in-game element, the user may have motivation to select one or some of various in-game elements, and as a result, it becomes possible to encourage the user to use the in-game element widely. Further, by providing a plurality of setting frames, each of which has a different property than those of the other setting frames, in the in-game element, a combination Ability that has become an available state is different depending upon with which setting frame the same Ability is combined. For this reason, the user is required to have a strategic characteristic, and it is possible to obtain an effect in which interest of the user in the video game is increased.

In this regard, it has not been mentioned particularly in each of the first to fifth embodiments described above. However, the server 10 may be configured so as to set a combination Ability to an available state by combining an Ability that has become an available state with an Ability using an in-game element at this time as the Ability. By configuring the server 10 in this manner, even though the server 10 is configured so that the combination Ability based on the combination of one Ability and the other Ability can be used, the effects similar to that of each of the first to fifth embodiments can be obtained.

Further, it has not been mentioned particularly in each of the first to fifth embodiments described above. However, the server 10E may be configured so that a combination Ability that has become an available state is allowed to be further combined with an in-game element. By configuring the server 10E in this manner, the combination Ability can further be combined with the in-game element to generate a sophisticated (more complicated) combination, and this makes it possible to obtain an effect in which interest of the user in the video game is increased.

Further, it has not been mentioned particularly in each of the first to fifth embodiments described above. However, the server 10 may be configured so that a capacity (or an ability) of an in-game element is improved by using a combination Ability that has become an available state. The configuration to improve the capacity (or the ability) of the in-game element is not limited particularly. However, for example, the server 10 may be configured so that a user who uses a combination Ability and satisfies a predetermined condition can obtain an element for reinforcing a setting frame of an in-game element as a basis of the combination Ability.

As one example, a configuration in which in a case where a job is a monk and a setting frame of the monk is “hand grenade”, the user continuously uses a combination Ability “hand grenade thunder” and satisfies a predetermined condition, whereby a player character can learn a reinforcing element “enlargement of an attack range” is thought. By causing the player character to learn and use this reinforcing element, there is a merit that the property of the setting frame “an attack to a middle distance” can be reinforced to enlarge an attack range. In addition, the server 10 may be configured so that the player character can learn a reinforcing element “attack power up”. Further, by configuring the server 10 so that the player character can learn a plurality of reinforcing elements, the user may be allowed to select and use an arbitrary reinforcing element of the reinforcing elements obtained by the user.

By configuring the server 10E in this manner, the user can get a merit in a case where the user continuously uses the combination Ability. Therefore, the user may have motivation to use the combination Ability, and as a result, it becomes possible to encourage the user to use the in-game element widely.

Further, in each of the first to fifth embodiments, it has been explained that an Ability becomes an available state in a case where a predetermined condition for the Ability associated with an in-game element. Further, it has been explained that the available state mentioned herein at least includes a situation that it becomes a state where an Ability can be combined with an in-game element. However, it has been explained that it is not a problem whether the Ability can be used by a single unit or not. The phrase “use an Ability by a single unit” means that even in a case where an Ability is not used to set a combination Ability to an available state, the Ability can be used as an option of an action command of a player character or the Ability can be used in order to raise a capacity parameter (or an ability parameter) of the player character.

Here, for example, the server 10 may be configured so that even though an Ability associated with an in-game element becomes an available state, the user is not allowed to use the Ability by a single unit; but the user is allowed to use a combination Ability that has become an available state on the basis of a combination of the Ability and the in-game element by a single unit. By configuring the server 10 in this manner, it is possible to create a situation in which the user cannot get a merit so long as an Ability is combined with an in-game element to form a combination Ability and the combination Ability is set to an available state even when only the Ability is set to an available state. Therefore, as a result, it becomes possible to encourage the user to use the in-game element widely.

As explained above, one or two or more shortages can be solved by each of the embodiments of the present application. In this regard, the effects according to each of the embodiments are non-limiting effects or one example of the non-limiting effects.

In this regard, in each of the embodiments described above, each of the plurality of user terminals 20 and 201 to 20N and the server 10 carries out the various kinds of processing described above in accordance with various kinds of control programs (for example, a video game processing program) stored in the storage device with which the corresponding terminal or server is provided.

Further, a configuration of the system 100 is limited to the configuration that has been explained as an example of each of the embodiments described above. For example, the system 100 may be configured so that part or all of the processing that has been explained as the processing carried out by the user terminal is carried out by the server 10, or it may be configured so that part or all of the processing that has been explained as the processing carried out by the server 10 is carried out by any of the plurality of user terminals 20 and 201 to 20N (for example, the user terminal 20). Further, the system 100 may be configured so that a part or all of the storing sections included by the server 10 is included in any of the plurality of user terminals 20 and 201 to 20N. Namely, the system 100 may be configured so that a part or all of the functions included in any one of the user terminal 20 and the server 10 according to the system 100 is included in the other.

Further, the program may be configured so as to cause a single apparatus that does not include a communication network to realize a part or all of the functions that have been explained as the examples of the respective embodiments described above.

In this regard, the word “in accordance with progress of the video game” means that occurrence of various kinds of progress or changes and the like that can be generated in the video game becomes timing or a standard of a specific process. As examples of the specific process, there are a determining process, an information updating process, and the like. Further, as examples of the various kinds of progress or changes that can be generated in the video game, there are progress of time, a change in a game element value, a specific status or update of a flag, an operation input by the user, and the like.

(Appendix)

The explanation of the embodiments described above has been described so that the following inventions can be at least realized by a person having a normal skill in the art to which the present invention belongs.

(1)

A non-transitory computer-readable medium including a video game processing program product for causing a server to realize functions to control progress of a video game in response to an operation of a user,

wherein the functions include:

a first setting function configured to set an ability to an available state when a predetermined available condition for the ability is satisfied, the ability being associated with an in-game element in the video game; and

a second setting function configured to set a combination ability to an available state, the combination ability corresponding to a combination of an in-game element selected by the user and the ability that becomes, became or has become the available state by the setting of the first setting function.

(2)

The non-transitory computer-readable medium according to claim (1),

wherein the second setting function includes a function configured to determine an ability that has become an available state to combine with an in-game element on the basis of selection of the user.

(3)

The non-transitory computer-readable medium according to claim (1) or (2),

wherein the ability that has become the available state is allowed to be combined with an in-game element that is different from the in-game element for which the ability becomes the available state.

(4)

The non-transitory computer-readable medium according to any one of claims (1) to (3),

wherein a setting frame for combining with the ability that has become the available state is provided in the in-game element,

wherein a property is set for the setting frame, and

wherein the second setting function includes a function configured to determine a combination ability on the basis of the ability that has become the available state and the property of the setting frame.

(5)

The non-transitory computer-readable medium according to claim 4),

wherein a plurality of setting frames each of which has a different property than other setting frames are provided in the in-game element, and

wherein the second setting function includes a function configured to cause the content of the combination ability to become different from those of the others depending upon the property of the setting frame on the basis of which setting frame the ability is combined with even though the ability is the same ability.

(6)

The non-transitory computer-readable medium according to claim (1),

wherein the in-game element is an ability, and

wherein the second setting function is configured to set the combination ability to the available state by combining the ability that has become the available state with the ability.

(7)

The non-transitory computer-readable medium according to any one of claims (1) to (6),

wherein the second setting function is configured to further combine the combination ability that has become the available state with an in-game element.

(8)

The non-transitory computer-readable medium according to any one of claims (1) to (6),

wherein the ability that is an object of the first setting function is allowed to be combined with an in-game element, but not to be used by a single unit, and

wherein the combination ability set by the second setting function is allowed to be used by a single unit.

(9)

The non-transitory computer-readable medium according to any one of claims (1) to (8),

wherein at least one ability that has been set to an available state since an initial state is associated with the in-game element.

(10)

A non-transitory computer-readable medium including a video game processing program product for causing a user terminal to realize at least one function of the functions that the video game processing program product described in any one of claims (1) to (9) causes the server to realize, the user terminal being capable of communicating with the server.

(11)

A server into which the video game processing program product included in the non-transitory computer-readable medium according to any one of claims (1) to (10) is installed.

(12)

A non-transitory computer-readable medium including a video game processing program product for causing a user terminal to realize functions to control progress of a video game in response to an operation inputted into the user terminal by a user,

wherein a server includes:

a first setting function configured to set an ability to an available state when a predetermined available condition for the ability is satisfied, the ability being associated with an in-game element in the video game; and

a second setting function configured to set a combination ability to an available state, the combination ability corresponding to a combination of an in-game element selected by the user and the ability that has become the available state by the setting of the first setting function, and

wherein the functions include:

a receiving function configured to receive information regarding the functions included in the server; and

an inputting/outputting function configured to carry out an input and output corresponding to the functions included in the server.

(13)

A non-transitory computer-readable medium including a video game processing program product for causing a user terminal to realize functions to control progress of a video game in response to an operation of a user,

wherein the functions include:

a first setting function configured to set an ability to an available state when a predetermined available condition for the ability is satisfied, the ability being associated with an in-game element in the video game; and

a second setting function configured to set a combination ability to an available state, the combination ability corresponding to a combination of an in-game element selected by the user and the ability that has become the available state by the setting of the first setting function.

(14)

A non-transitory computer-readable medium including a video game processing program for causing a server to realize at least one function of the functions that the video game processing program product described in claim (13) causes the user terminal to realize, the server being capable of communicating with the user terminal.

(15)

A user terminal into which the video game processing program product included in the non-transitory computer-readable medium according to any one of claims (12) to (14) is installed.

(16)

A video game processing system for controlling progress of a video game in response to an operation of a user, the video game processing system including a communication network, a server, and a user terminal, the video game processing system comprising:

a first setting section configured to set an ability to an available state when a predetermined available condition for the ability is satisfied, the ability being associated with an in-game element in the video game; and

a second setting section configured to set a combination ability to an available state, the combination ability corresponding to a combination of an in-game element selected by the user and the ability that has become the available state by the setting of the first setting section.

(17)

The video game processing system according to claim (16),

wherein the server includes the first setting unit and the second setting unit, and

wherein the user terminal includes:

a transmitting/receiving section configured to transmit and receive information regarding the video game; and

an outputting section configured to output a game screen on a display screen of a display device.

(18)

A video game processing method of controlling progress of a video game in response to an operation of a user, the video game processing method comprising:

a first setting process configured to set an ability to an available state when a predetermined available condition for the ability is satisfied, the ability being associated with an in-game element in the video game; and

a second setting process configured to set a combination ability to an available state, the combination ability corresponding to a combination of an in-game element selected by the user and the ability that has become the available state by setting in the first setting process.

(19)

A video game processing method executed by a video game processing system to control progress of a video game in response to an operation inputted to a user terminal by a user, the video game processing system comprising a communication network, a server, and the user terminal, the video game processing method comprising:

a first setting process configured to set an ability to an available state when a predetermined available condition for the ability is satisfied, the ability being associated with an in-game element in the video game; and

a second setting process configured to set a combination ability to an available state, the combination ability corresponding to a combination of an in-game element selected by the user and the ability that has become the available state by setting in the first setting process.

According to one of the embodiments of the present invention, it is useful to encourage a user to use an in-game element widely in a video game.

What is claimed is:

1. A non-transitory computer-readable medium including a video game processing program product for causing a server to realize functions to control progress of a video game in response to an operation of a user,
wherein the functions include:
a first setting function configured to set an ability to an available state when a predetermined available condition for the ability is satisfied, the ability being associated with an in-game element in the video game; and
a second setting function configured to set a combination ability to an available state, the combination ability corresponding to a combination of an in-game element selected by the user and the ability that has become the available state by the setting of the first setting function.

2. The non-transitory computer-readable medium according to claim 1,
wherein the second setting function includes a function configured to determine an ability that has become an available state to combine with an in-game element on the basis of selection of the user.

3. The non-transitory computer-readable medium according to claim 1,
wherein the ability that has become the available state is allowed to be combined with an in-game element that is different from the in-game element for which the ability becomes the available state.

4. The non-transitory computer-readable medium according to claim 1,
wherein a setting frame for combining with the ability that has become the available state is provided in the in-game element,
wherein a property is set for the setting frame, and
wherein the second setting function includes a function configured to determine a combination ability on the basis of the ability that has become the available state and the property of the setting frame.

5. The non-transitory computer-readable medium according to claim 4,
wherein a plurality of setting frames each of which has a different property than other setting frames are provided in the in-game element, and
wherein the second setting function includes a function configured to cause the content of the combination ability to become different from those of the others depending upon the property of the setting frame on the basis of which setting frame the ability is combined with even though the ability is the same ability.

6. The non-transitory computer-readable medium according to claim 1,
wherein the in-game element is an ability, and
wherein the second setting function is configured to set the combination ability to the available state by combining the ability that has become the available state with the ability.

7. The non-transitory computer-readable medium according to claim 1,
wherein the second setting function is configured to further combine the combination ability that has become the available state with an in-game element.

8. The non-transitory computer-readable medium according to claim 1,
wherein the ability that is an object of the first setting function is allowed to be combined with an in-game element, but not to be used by a single unit, and
wherein the combination ability set by the second setting function is allowed to be used by a single unit.

9. The non-transitory computer-readable medium according to claim 1,
wherein at least one ability that has been set to an available state since an initial state is associated with the in-game element.

10. A non-transitory computer-readable medium including a video game processing program product for causing a user terminal to realize at least one function of the functions that the video game processing program product described in claim 1 causes the server to realize, the user terminal being capable of communicating with the server.

11. A server into which the video game processing program product included in the non-transitory computer-readable medium according to claim 1 is installed.

12. A non-transitory computer-readable medium including a video game processing program product for causing a user terminal to realize functions to control progress of a video game in response to an operation of a user,
wherein the functions include:
a first setting function configured to set an ability to an available state when a predetermined available condition for the ability is satisfied, the ability being associated with an in-game element in the video game; and
a second setting function configured to set a combination ability to an available state, the combination ability corresponding to a combination of an in-game element selected by the user and the ability that has become the available state by the setting of the first setting function.

13. A video game processing system for controlling progress of a video game in response to an operation of a user, the video game processing system including a communication network, a server, and a user terminal, the video game processing system comprising:
a first setting section configured to set an ability to an available state when a predetermined available condition for the ability is satisfied, the ability being associated with an in-game element in the video game; and
a second setting section configured to set a combination ability to an available state, the combination ability corresponding to a combination of an in-game element selected by the user and the ability that has become the available state by the setting of the first setting section.
